(19) United States
(12) Patent Application Publication
(10) Pub. No.: US 2014/0229279 A1
(43) Pub. Date: Aug. 14, 2014

(54) PROVIDING ADVERTISING CONTENT BASED ON A MAP REPORT

(71) Applicant: NAVTEQ B.V., Veldhoven (NL)

(72) Inventor: Cory James Hohs, Chicago, IL (US)

(73) Assignee: NAVTEQ B.V., Veldhoven (NL)

(21) Appl. No.: 13/767,614

(22) Filed: Feb. 14, 2013

(51) Int. Cl. G06Q 30/02

(52) U.S. Cl. CPC G06Q 30/0251
USPC 705/14.53; 705/14.49; 705/14.58

(57) ABSTRACT

Advertising content may be provided based on a map report. A map report may be received from a client device. The map report may be indicative of a perceived inaccuracy in geographic data stored in a geographic database. Advertising content may be provided to the client device based on the map report received from the client device.

### BACKGROUND

The present embodiments relate to providing advertising content.

Navigation systems or devices provide useful features, such as calculating routes to desired destinations or points of interest and providing guidance for following those routes. In order to provide these features, navigation systems use geographic data that include information about the locations of roads and intersections, points of interest, topographical features, estimated travel times and speed limits along road segments, etc.

The collection of geographic data for use in navigation systems may be a significant undertaking. For example, the initial collection of data about the roads, destinations, and points of interest in a geographic area may be time consuming. Also, geographic data used in navigation systems may become out-of-date. For example, new roads may be built and/or close (e.g., due to road construction), businesses may change locations, open, or close, etc. There also may be errors in collected geographic data.

Accordingly, end users relying on navigation systems may discover that certain geographic data used in their navigation systems are not up-to-date, incorrect, or inaccurate.

Updating and verifying the accuracy of geographic data may, however, be time-intensive and expensive. To help offset this, map developers may ask end users to provide reports that indicate when geographic data in their navigation systems are not up-to-date, inaccurate, or incorrect. Nonetheless, map developers may still have to expend significant efforts to verify the accuracy of these reports and, when appropriate, update or correct the geographic data.

### SUMMARY

To address these and other objectives, the present embodiments relate to providing advertising content based on a map report to help offset costs.

A method for providing advertising content based on a map report may be provided. A map report may be received from a client device. The map report may be indicative of a perceived inaccuracy in geographic data stored in a geographic database.

Advertising content may be provided to the client device based on the map report received from the client device.

### BRIEF DESCRIPTION OF THE DRAWINGS

Exemplary embodiments of the present invention are described herein with reference to the following drawings:

FIG. 1 depicts an exemplary map of a geographic region;

FIG. 2 depicts a block diagram of one embodiment of a system for providing advertising content based on a map report;

FIG. 3 depicts a more detailed view of an exemplary navigation system of the system of FIG. 2;

FIG. 4 depicts a more detailed view of an exemplary client device of the system of FIG. 2;

FIG. 5 depicts a flow chart showing one embodiment of a method for providing advertising content based on a map report; and

FIG. 6 depicts an exemplary computer system for use with the system of FIG. 2.

### DETAILED DESCRIPTION OF THE PRESENTLY PREFERRED EMBODIMENTS

The present embodiments aim to provide methods, computer readable storage media with instructions, and systems for providing advertising content to a client device based on a map report. The map report may include one or more perceived inaccuracies (e.g., one or more omissions, one or more deletions to be made, one or more errors, etc.) in geographic data stored in a geographic database. The accuracy of the map report may be verified, and, in turn, the map report may be used to update the geographic database. Such a process is, however, expensive and time-consuming, particularly because it is an on-going process.

The present embodiments aim to offset some of the significant costs associated with this process. The present embodiments may provide advertising content based on the map report. In return for providing advertising content, the operator of the geographic database may be compensated by advertisers, thus allowing the operator to recoup some of the costs incurred by the operator as part of the process of verifying the accuracy of the map report and updating the geographic database in accordance with the map report. Moreover, the present embodiments aim to tailor the advertising content provided to the client device by providing the advertising content based on information in the map report. For example, the present embodiments may tailor the advertising content to a specific end user of the client device by extracting user preferences, behavior, activities, and/or interests from data in the map report. Other tailoring may be based on a location or other information associated with the map report. By tailoring the advertising content, the present embodiments may allow the operator to charge an even higher premium for providing the advertising content, thereby allowing the operator to recoup an even higher percentage of the costs associated with the process of updating the geographic database.

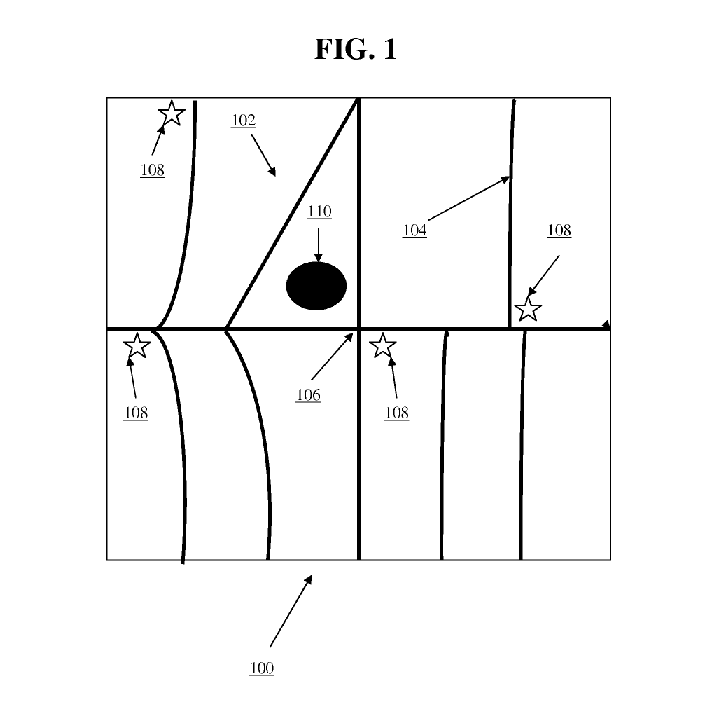

FIG. 1 is diagram illustrating a geographic region 100. The region 100 may be a country (e.g., France), state (e.g., Illinois), province, city (e.g., Chicago), metropolitan area (e.g., the New York metropolitan area), county (e.g., Cook County, Illinois), any other municipal entity, or any other area of comparable or different size. Alternatively, the geographic region 100 may be a combination of one or more countries, states, cities, metropolitan areas, and so on. The region 100 may represent locations without reference to geo-political boundaries, such as being a rectangular region centered on or relative to a particular point or location.

The region 100 includes a road network 102. The road network 102 may include, among other things, a plurality of road segments 104 connected at intersections 106 throughout the region 100. The region 100 also includes one or more points of interest (“POIs”) 108, such as businesses, stores, municipal entities, tourist attractions, and/or other points of interest not explicitly described herein. The region 100 further includes one or more topographical features 110 (e.g., bodies of water, mountains, hills, etc.) of the geographic region 100.

Though not depicted herein, the region 100 may also or alternatively include a pedestrian network having sidewalks and pedestrian paths, a bicycle network having bike paths, bike lanes on road segments, and/or road segments appropriate for bicycle travel, a public transit network including, for example, railroads, public bus lines, tourist bus lines, metro railway lines (e.g., subways and elevated lines), light rail (e.g., trams, trolleys, or street cars), water taxi, and stations and/or stops for one or more of each, or combinations thereof. The region 100 may include other networks, features, and/or points as well. The road network 102, particularly one or more of the road segments 104 and/or the intersections 106, the points of interest 108, the topographical features 110, or combinations thereof, may, in other embodiments, vary from what is depicted in FIG. 1. Any given region may or may not include one or more of these features, points, or networks.

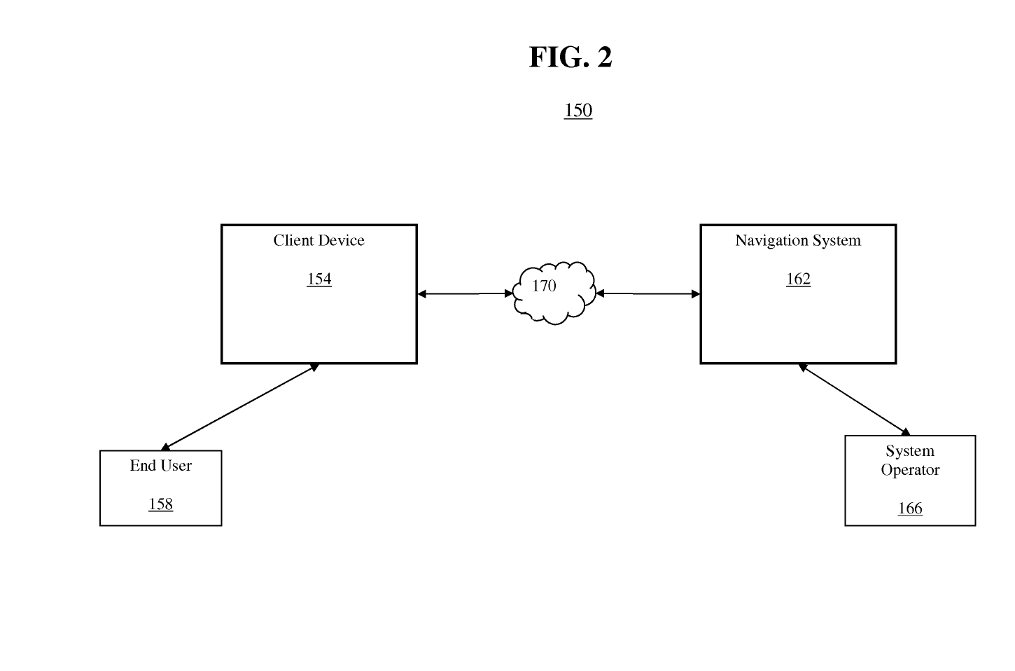

FIG. 2 shows a block diagram of one embodiment of a system 150 for providing advertising content based on a map report. The system 150 generally includes a client device 154 associated with (e.g., owned, operated by) an end user 158, and a navigation system 162 developed and/or operated by, or otherwise associated with, a system operator 166 (e.g., Nokia Corp.). In this embodiment, the client device 154 is coupled with or connected to the navigation system 162 via a wired or wireless communication network 170.

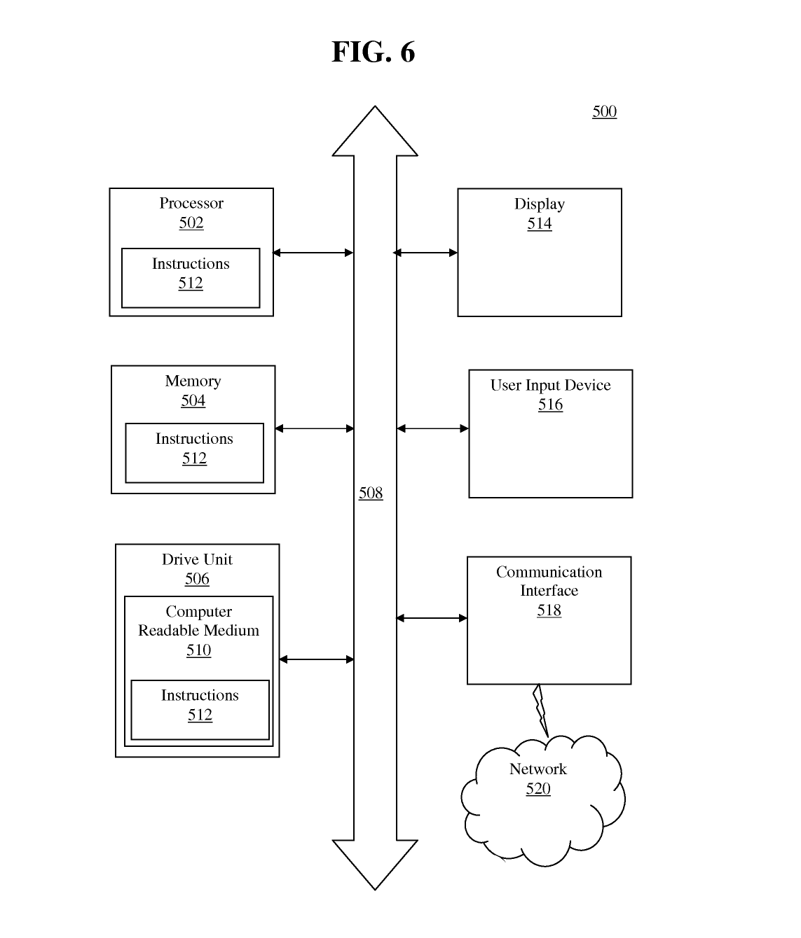

In other embodiments, the system 150 may include additional, different, or fewer components. For example, additional client devices 154, end users 158, and/or networks 170 may be provided. In other embodiments, the navigation system 162, or components thereof, may be partially or fully located within or be part of the client device 154. For example, the client device 154 may contain the navigation system 162. In other embodiments, the navigation system 162 (or individual components thereof, as described below) may be implemented as computer program logic or computer readable program code stored in a memory and/or storage of a computer, such as the computer 500 described below with respect to FIG. 6, and executable by one or more processors thereof to implement the disclosed functionality.

The network 170 may be a wireless network or a combination of a wired and wireless network, such as a cellular telephone network and/or 802.11x compliant network, and may include a publicly accessible network, such as the Internet, a private network, or combination thereof. The type and configuration of the communications network 170 is implementation dependent, and any type of communications network, available now or later developed, that facilitates the described communications between the client device 154 and the navigation system 162 may be used. As used herein, the phrases “in communication” and “couple” include direct connections or indirect connections through one or more intermediate components. Such intermediate components may include hardware and/or software based components.

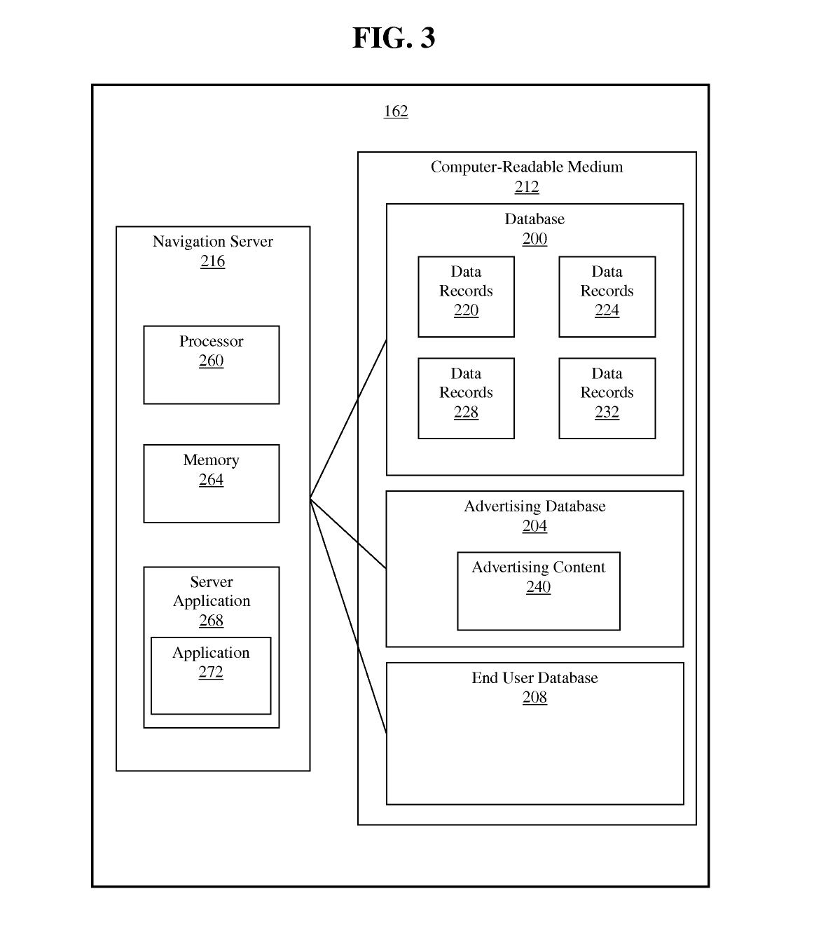

FIG. 3 shows a block diagram of the navigation system 162 in greater detail.

The navigation system 162 includes a geographic or navigation database 200, an advertising database 204, and an end user database 208. The geographic database 200, the advertising database 204, and the end user database 208 are stored on a computer readable medium 212, which may include one or more hard drives or other storage medium. The system 162 further includes a server 216 that may access the computer readable medium 212. In other embodiments, the navigation system 162 may include additional, different, or fewer components. For example, the advertising database 204 and/or the end user database 208 may be separate from the navigation system 162 (i.e., stored elsewhere) or combined into one database. As another example, the server 216 may be part of or separate (e.g., remote) from the geographic database 200, the advertising database 204, and/or the end user database 208.

The geographic database 200 stores or maintains geographic data, such as, for example, road segment or link data records 220, node data records 224, point of interest data records 228, and topographical data records 232. In other embodiments, the geographic database may store additional, fewer, or different geographic data. For example, the geographic data may also include other data records, such as, for example, cartographic data records, routing data, images, and maneuver data.

The link data records 220 are links or segments representing the roads, streets, or paths 104. The node data records 224 are end points (e.g., the intersections 106) corresponding to the respective links or segments of the road segment data records 220. The road data link records 220 and the node data records 224 may represent, for example, the road network 102 or other road networks used by vehicles, cars, and/or other devices. The road link data records 220 may be associated with attributes of or about the roads 104, such as geographic coordinates, street names, address ranges, speed limits, turn restrictions at intersections, and other navigation related attributes (e.g., one or more of the road segments 104 is part of a highway or tollway, the location of stop signs and/or stoplights along the road segments 104, etc.), as well as any of the POIs 108, such as gasoline stations, hotels, restaurants, museums, stadiums, offices, automobile dealerships, auto repair shops, buildings, stores, parks, etc. Any organization and type of information may or may not be included.

The node data records 224 may likewise be associated with attributes (e.g., about the intersections 106), such as geographic coordinates, street names, address ranges, speed limits, turn restrictions at intersections, and other navigation related attributes, as well as any of the POIs 108, such as gasoline stations, hotels, restaurants, museums, stadiums, offices, automobile dealerships, auto repair shops, buildings, stores, parks, etc. The point of interest data records 228 may be associated with attributes of or about one or more of the points of interest 108, such as an address, a phone number, hours of operation, a classification, type, or category (e.g., restaurant, hotel, coffee shop, museum, etc.), a sub-type, sub-classification, or sub-category (e.g., steak restaurant, luxury hotel, etc.) of or for the point of interest 108. The topographical data records 232 may be associated with attributes of or about the topographical features 110 (e.g., lakes, ponds, rivers, mountains, etc.), such as geographic coordinates, names, size (height/depth/width), temperature, etc. Any organization and type of information may or may not be included.

The advertising database 204 stores or maintains advertising data or content 240. The advertising content or data 240 is provided by one or more advertisers and may include product and/or service advertising or marketing content, such as, for example, product or service information, store or restaurant listings, financial incentives (e.g., coupons, rebates, discounts, or deals), or combinations thereof, associated with one or more products and/or services. The advertising content may include or be text, one or more images, video content (e.g., one or more videos or video clips), audio content, other content, or combinations thereof, stored in any number of different formats (e.g., HTML, JPEG, Bitmap, Tiff, SVG, AVI, MOV, MPG, WMV, MP3, WAV, etc.). The advertising content 240 may be location-neutral (e.g., advertising content for Starbucks) and/or may be tailored to a specific geographic location (e.g., advertising content for the Chicago Cubs or POI related content).

The advertising content 240 may include or be associated with (1) an advertisement identification by which the content 240 may be identified or referenced in the database 204, (2) one or more delivery conditions and/or guidelines (e.g., the associated advertising content should only be delivered on certain days, between certain hours of the day, etc.), (3) user demographic data (e.g., sex, education level, income level) that may indicate or identify the target demographic for the content 240, (4) preferences, interests, behaviors, and/or activities of, for, or associated with an end user, (5) one or more types of map reports (e.g., POI map reports, road network map reports), (6) one or more road segments 104, one or more POIs 108, one or more other geographic features, or combinations thereof, in the region 100, (7) one or more types, categories, or classifications of one or more geographic features, such as one or more types of POI (e.g., a restaurant, a hotel, a tourist attraction), (8) one or more sub-types, categories, or classifications of one or more geographic features, such as, for example, one or more sub-types of POI (i.e., sub-types, categories, or classifications of a specific type of POI) (e.g., steak restaurants, sports stadiums, etc., (9) one or more geographic locations or positions (e.g., corresponding to one or more brick and mortar stores) and/or one or more defined spatial or geo-fenced areas (e.g., the Lakeview neighborhood), (10) a type of map inaccuracy (e.g., missing geographic feature, incorrect geographic feature, or geographic feature to be deleted) included in a map report, or (11) combinations thereof. In other embodiments, the advertising content 240 may be associated with additional or different attributes, parameters, or data.

The end user database 208 stores or maintains preferences, permissions, settings, and/or a profile for or corresponding to the end user 158 and other end users. For example, the end user database 208 may store identifiers or other indicators, such as network identifiers (e.g., IP addresses), telephone numbers, email addresses, etc., of or for the end user 158 and other end users. The end user database 208 also stores or maintains data indicative of one or more map reports, and/or perceived inaccuracies included therein, previously or currently provided by and received from the end user 158 and/or other end users. For example, the end user database 208 may store data indicative of a map report received from the end user 158 detailing that a POI data record 228 for a restaurant POI in the geographic database 200 was incorrect. The end user database 208 may, in some embodiments, maintain separate user accounts for each end user in which user-specific data or information may be stored. Other arrangements may be used, such as storing reports combined from multiple users. As will be described in greater detail below, any of the data or information stored in the end user database 208 may be utilized when providing advertising content 240 to the end user 158 or another end user.

The server 216 may be any type of server, such as an application server, a database server, a file server, a web server, or other server. The server 216 may include one or more computers and/or may be part of a larger network of servers. The server 216 includes a processor 260, a memory 264, and a server application 268. The server application 268 may be stored on one or more hard drive(s), cache, RAM, or other computer-readable media operated by the server 216 and loaded into the memory 264 of the server 216 to be executed by the processor 260. In other embodiments, the server 216 may include additional, different, or fewer components.

The server application 268 includes an advertising application 272. The advertising application 272 generally provides advertising content 240 to the client device 154 based on a received map report. More specifically, the advertising application 272 creates, formats, and transmits advertising content 240 to the client device 154 based on a received map report. The advertising application 272 may be written in a suitable computer programming language such as C, although other programming languages, such as C++ or Java, are also suitable.

The server application 268 may also include a navigation-related server application that provides various navigation features and functions. The navigation-related server application may obtain or access the geographic data stored or maintained in the geographic database 200. In turn, the navigation-related server application may provide different geographic information, content, services, features, and/or functions to the end user 158 of the client device 154. The navigation-related server application may, for example, generate or provide one or more maps for the end user 158. The navigation-related server application may, alternatively or in addition thereto, provide or generate route calculation and/or route guidance for the end user 158, and/or provide other navigation-related or map-related information (e.g., position identification). The navigation-related server application may be written in a suitable computer programming language such as C, although other programming languages, such as C++ or Java, are also suitable.

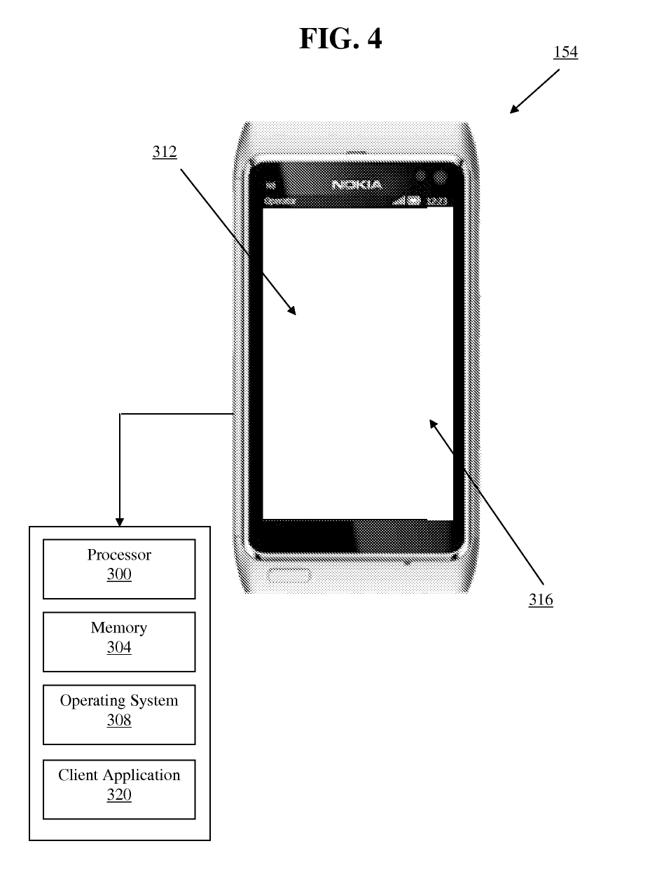

FIG. 4 shows one embodiment of the client device 154. In the illustrated embodiment, the client device 154 is a mobile device (e.g., manufactured by Nokia Corp.), such as a smart phone, a mobile phone, a personal digital assistant (“PDA”), a tablet computer, a notebook computer, a personal navigation device (“PND”), a portable navigation device, and/or any other known or later developed portable or mobile device, associated with the user 108. When the client device 154 is a mobile device, the client device 154 may be associated with vehicles (e.g., cars, trucks, motorcycles) that travel on the road network 102 or may be associated with (e.g., carried by) a pedestrian or person traveling via bicycle, public transportation, or some other mode of transportation in the region 100. In other embodiments, the client device 154 may be a desktop computer, workstation, or any other known or later developed non-portable or non-mobile client device associated with the user 108.

As shown in FIG. 4, the client device 154 includes a processor 300, a memory 304, an operating system 308, an input device 312, a display 316, and a software application 320. In other embodiments, the client device 154 may include additional, fewer, or different components. For example, the client device 154 may include additional input devices 312 and/or software applications. As mentioned above, in other embodiments, the client device 154 may include the navigation system 162, or components thereof.

The processor 300 may be a general processor, a digital signal processor, ASIC, field programmable gate array, graphics processing unit, analog circuit, digital circuit, combinations thereof, or any other known or later developed processor. The processor 300 operates pursuant to instructions in the memory 304.

The memory 304 may be a volatile memory or a non-volatile memory. The memory 304 may include one or more of a read only memory (ROM), random access memory (RAM), a flash memory, an electronic erasable program read only memory

(EEPROM), or other type of memory. The memory 304 may include an optical, magnetic (hard drive) or any other form of data storage device. The memory 304 may be removable from the client device 154 (e.g., may be a secure digital (SD) memory card).

The operating system 308 is installed on or in the memory 304 of the client device 154 or a separate memory. The operating system 308 may be Linux, Microsoft Windows, Android, iOS, Windows CE, MAC OS X, or any other operating system.

The input device 312 may be or include one or more buttons, a keypad, a keyboard, a mouse, a stylist pen, a trackball, a rocker switch, a touch pad, a voice recognition circuit, a touch screen, or other device or component for inputting data to the client device 154. As will be described in greater detail below, the end user 158 may, via or using the input device 312, provide (e.g., enter, generate, submit) data indicative of a perceived inaccuracy in the geographic information and/or a map report indicative of a perceived inaccuracy in the geographic information.

The display 316 may be a liquid crystal display (LCD) panel, light emitting diode (LED) screen, thin film transistor screen, or another type of display. The display 316 is configured to display content obtained or received from the server 216, such as, for example, content based on or for the software application 320 and/or advertising content 240. As shown in FIG. 4, in the illustrated embodiment, the mobile device 154 has a touch screen, which may be capacitive, resistive, surface acoustic wave, or another type, such that the input device 312 and the display 316 are the same.

In some embodiments, the client device 154 also includes a positioning system. The positioning system may include a global positioning system (GPS) or a cellular or similar position sensor for providing location or position data for, of, or about the client device 154. The positioning system may utilize GPS-type technology, a dead reckoning-type system, cellular location, or combinations of these or other systems. The positioning system may include suitable sensing devices that measure the traveling distance, speed, direction, and so on, of the client device 154. The positioning system may also include a receiver and correlation chip to obtain a GPS signal.

In some embodiments, the client device 154 includes a camera. The camera is configured to capture still and/or video images of the geographic region 100, such as, for example, geographic features (e.g., roads, intersections, POIs,) in the region 100. The camera includes, but is not limited to, a lens and circuitry for taking pictures. Additional, fewer, or different components may be provided. For example, a flash or flash circuitry may be provided.

In embodiments in which the client device 154 is a mobile device, the camera may be located on or built into a front surface or face (e.g., a top right-hand corner of the front surface or face), located on or built into a rear surface or face, or located elsewhere in or on the client device 154. In embodiments in which the client device 154 is not a mobile device, the camera may be located on or built into the display 316, or coupled to or connected with the client device 154. The camera may be positioned so that the lens is facing away from the display 316, facing in the same direction as the display 316, or in a different direction. The camera may be moved between any of these different positions.

The software or client application 320 is an application that is installed and executable on the operating system 308 of the client device 154 and allows the end user 158 to describe or identify perceived inaccuracies in the geographic database 200 and/or provide (e.g., generate, form, submit) an map report identifying or describing perceived inaccuracies in the geographic database 200. The software application 320 also provides (e.g., presents, outputs) the associated end user 158 with, or allows the end user 158 to receive, advertising content from the server 216. The software application 320 may also provide (e.g., presents, outputs) the associated end user 158 with, or allow the end user 158 to receive or use, geographic or navigational information, content, services, features, and/or functions (e.g., one or more maps, route calculation, route guidance, etc.). In some embodiments, another software application may be installed and executable on the operating system 308 and provide the associated end user 158 with, or allow the end user 158 to receive or use, geographic or navigational information, content, services, features, and/or functions.

The software application 320 may be a Web browser (e.g., Firefox, Internet Explorer), an email application, a messaging application, or other plug in or proprietary application built into or installed on the operating system 308. When, for example, the client device 154 is a mobile or smart phone, the software application 320 may be any type of mobile or smart phone application (“app”). In one embodiment, the software application 320 is a Web browser that retrieves and provides a web page, such as www.mapreporter.com, to the end user 158 for describing or identifying perceived inaccuracies in the geographic database 200 and/or providing (e.g., generating, submitting) an map report identifying or describing perceived inaccuracies in the geographic database 200. The software application 320 may be written in a suitable computer programming language such as C, although other programming languages (e.g., C++, Java, etc.) are also suitable.

With reference again to FIG. 2, the end user 158 may perceive (e.g., discover, recognize) one or more inaccuracies in the geographic data stored in the geographic database 200. The end user 158 may perceive one or more inaccuracies in the geographic data from or due to geographic or navigational information, such as maps, route guidance, route calculation, including one or more inaccuracies. The one or more perceived inaccuracies may include erroneous geographic data, such as, for example, an erroneous street name, an erroneous road connection, an erroneous POI name, an erroneous road or road portion, or an erroneous POI. For example, the geographic information may include erroneous data about one of the link data records 220 (e.g., the data may indicate that the road 102 represented by the link data record 220 is a two-way street when it is in fact a one-way street). The one or more perceived inaccuracies may, alternatively or additionally, include missing or omitted geographic data, such as, for example, a missing road, a missing POI, or a missing road connection. For example, the geographic information may not include a steak restaurant POI 108 located along one of the roads 102 in the geographic region 100. The one or more perceived inaccuracies may, alternatively or additionally, include existing geographic data to be deleted or removed, such as, for example, a road to be deleted or a POI to be deleted from the geographic database. For example, the geographic information may include a restaurant POI 108 that is in fact no longer there (i.e., existing geographic data to be deleted). The geographic or navigational information may be provided to the end user 158 via the client device 154 (e.g., the client application 320, another client application) or via another client device, or may be provided to another end user and relayed to the end user 158.

When or while the client application 320 is executing on the client device 154, the end user 158 may, using or via the client device 154, identify (e.g., describe, upload, record) those perceived inaccuracies, and provide information pertaining thereto, in the client application 320. The end user 158 may identify the perceived inaccuracies immediately after perceiving the inaccuracies, or may do so at a later time (e.g., the following day). The perceived inaccuracies may be identified, and information pertaining thereto provided, using or via the input device 312, the display 316, the positioning system of the client device 154, the camera of the client device 154, any other component(s) of the client device 154 (e.g., the speakers), or combinations thereof. The end user 158 may upload a picture, captured with the camera of the client device, of a real-world geographic feature in the geographic region 100 that illustrates the one or more perceived inaccuracies. The end user 158 may, using the input device 312 and/or the display 316, enter comment information that describes the one or more perceived inaccuracies. For example, the end user 158 may, using a keyboard of the client device 154, enter the following comment information in the client application 320: “the map does not include the steak restaurant located on the corner of Addison and Sheffield.” The position and/or orientation of the client device 154 may be manually entered by the end user 158 or automatically recorded by the client application 320 using the positioning system of the client device 154. Other information about the perceived inaccuracies may be provided as well.

The end user 158, using or via the client application 320, may form or generate a map report. The map report is indicative of (e.g., includes) one or more perceived inaccuracies in the geographic information (e.g., maps, route guidance, or route calculation) provided based on the geographic data stored in the geographic database 200. The map report may also be indicative of one or more perceived inaccuracies identified at an earlier and/or later time. Depending upon how the perceived inaccuracies are identified (e.g., which components of the client device 154 are used), the map report may include text (e.g., comment information, position data), such as text in extensible markup language (XML) and/or hypertext markup language (HTML), one or more images (e.g., photographs captured by the camera of the client device 154), video content, audio content, other data, or combinations thereof. The map report may be structured in any format. For example, the map report may be structured as an email or short message service (SMS). In some embodiments, the map report may be associated with a type, classification, or category, such as, for example, a POI map report (that includes one or more perceived inaccuracies corresponding to missing POI data, erroneous POI data, existing POI data to be deleted, or combinations thereof), an address map report (that includes one or more perceived inaccuracies corresponding to missing address data, existing address data to be deleted, erroneous address data, or combinations thereof), a road network map report (that includes one or more perceived inaccuracies corresponding to missing road and/or node data, existing road and/or node data to be deleted, erroneous road and/or node data, or combinations thereof), or a combination map report (that includes one or more perceived inaccuracies corresponding to different kinds of data). Other types, classifications, or categories may be used.

The map report is transmitted (e.g., sent, uploaded) to the server 216 via the network 170. The map report may be transmitted to the server 216 after it is generated (e.g., automatically by the client application 320 or manually by the end user 158) or at a later time. The map report may be transmitted later, such as after connection to a wired network or a WiFi network. In other embodiments, data indicative of the one or more perceived inaccuracies may be transmitted (e.g., sent, uploaded) to the server 216 via the network 170. The server 216 may, in turn, generate the map report locally.

In any event, when the server 216 receives or obtains the formed map report, the map report, and the information provided therein, may be used to update the geographic database 200. The map report may, for example, be used to correct the geographic data stored in the geographic database 200, delete or remove geographic data stored in the geographic database 200, and/or supplement the geographic data stored in the geographic database 200 to include previously missing geographic data. The geographic database 200 may be automatically updated (when, for example, the map report is sufficiently detailed) based on the map report. Alternatively, the map report may prompt or trigger the system operator 166 to dispatch an agent to visit the particular geographic location to collect addition data for the update or at least review the map report to authorize correction.

Verifying the accuracy of the map report and updating the geographic data stored in the geographic database 200 in accordance with the map report may, as noted above, be a time-intensive and expensive process. To help offset some of the expense of such a process, the present embodiments provide advertising content to the client device based on the map report. In return, the system operator 166 may receive compensation from advertisers for displaying the advertising content. This compensation may allow the system operator 166 to recoup some of the costs associated with updating the geographic database 200.

Accordingly, the server 216, particularly the advertising application 272, is configured to provide (e.g., create, format, generate) advertising content 240 to the client device 154 (e.g., the client application 320) based on the map report. To this end, the server 216 is configured to determine (e.g., extract, deduce) information from the map report. The information may be or include preferences, behavior, location, activities, interests, other information, or combinations thereof, of, for, or associated with the end user 158. For example, when the map report includes one or more perceived inaccuracies corresponding to a POI 108, the server 216 may determine that the end user 158 is familiar with (e.g., works near, lives near) the location of the POI 108 or that the end user 158 is interested in the POI 108 and/or other related POIs 108. The information may, alternatively or additionally, be or include a type of the map report (e.g., a POI map report, a road segment map report), one or more geographic features (e.g., a road 104, a POI 108, a topographical feature 110, etc.) corresponding to the one or more perceived inaccuracies in the map report, a type (or types) of geographic feature(s) corresponding to the one or more perceived inaccuracies in the map report, a sub-type (or sub-types) of geographic feature(s) corresponding to the one or more perceived inaccuracies in the map report, or combinations thereof. Other information may be determined as well. Alternatively, no information is gleaned from the map report.

In turn, the server 216 may store any of the information determined from the map report. The server 216 may store this information in the end user database 208. In embodiments in which the end user database 208 maintains separate user accounts for each end user, the server 216 may store this information in the user account for the end user 158. In other embodiments, the server 216 may store this information in a different database (e.g., one remotely located from the server 216). The server 216 may continually update the end user database 208 when additional map reports are obtained (e.g., received) and additional information is determined (e.g., extracted) from these additional map reports. By doing so, the server 216, particularly the advertising application 272, may be able to intelligently provide advertising content tailored to the end user 158. User specific information other than the information gleaned from map reports may be used instead or as well.

As noted above, the server 216 is configured to provide advertising content 240 to the client device 154 based on the map report or information specific to the user that generated the map report. In some embodiments, the server 216 is configured to provide advertising content 240 to the client device 154 based on the information determined (e.g., extracted) from and/or about the map report. As such, the advertising content 240 may be provided based on preferences, activities, interests, etc., of, for, or associated with the end user 158, the type of the map report, the one or more perceived inaccuracies in the map report, other information or data, or combinations thereof.

The advertising content 240 may be provided based on the type or category of the map report. For example, when the map report is a POI map report, advertising content 240 associated with this type of map report may be provided. As another example, when the map report is a road network map report, advertising content 240 associated with this type of map report may be provided.

The advertising content 240 may be provided based on the one or more perceived inaccuracies in the map report. When the map report includes a perceived inaccuracy involving erroneous data corresponding to one or more geographic features (e.g., a road segment 104, node 106, POI 108, topographical feature 110), advertising content 240 associated with those one or more geographic features may be provided. For example, when the map report includes a perceived inaccuracy that involves erroneous data corresponding to a POI 108 that is a sports stadium, sports-related advertising content 240, such as advertising content for that sports stadium, other sports stadiums, sports teams, or other sports-related advertising, may be provided. When the map report includes a perceived inaccuracy involving data to be deleted about or for one or more geographic features (e.g., a road segment, node 106, POI 108, etc.), advertising content 240 associated with those one or more geographic features may be provided. For example, when the map report includes a perceived inaccuracy that involves data to be removed for a POI 108 that is (was) a hotel, hotel-related advertising content, such as advertising content for nearby hotels, may be provided.

When the map report includes a perceived inaccuracy involving missing data, data to be removed, or erroneous data corresponding to one or more geographic features, advertising content 240 associated with a type or category (also referred to herein as a first hierarchical category) and/or a sub-type or sub-category (also referred to herein as a second hierarchical category) of, for, or associated with the one or more geographic features may be provided.

Exemplary types or categories include: (1) POI types or categories, such as, for example, restaurants, hotels, or tourist attractions, (2) road segment types or categories, such as, for example, highways, tollways, local roads, (3) types or categories of topographical features, such as, for example, bodies of water, and (4) types or categories of public transit, such as, for example, bus lines, railroad/railway lines, etc. For example, when the map report includes a perceived inaccuracy that involves erroneous data, data to be removed, or missing data corresponding to a POI 108 that is a restaurant, advertising content 240 associated with restaurants (the type of POI associated with the POI 108) may be provided. As another example, when the map report includes a perceived inaccuracy that involves erroneous data, data to be removed, or missing data corresponding to a topographical feature 110 that is a river, advertising content 240 associated with bodies of water may be provided.

Exemplary sub-types or sub-categories include: (1) POI sub-types or sub-categories (i.e., types of types of POIs), such as, for example, steak restaurants, luxury hotels, etc., and (2) transit network sub-types or sub-categories, such as, for example, light rail lines, metro rail lines, public bus lines, etc. For example, when the map report includes a perceived inaccuracy that involves erroneous data, data to be removed, or missing data corresponding to a POI 108 that is a steak restaurant, advertising content 240 associated with steak restaurants (a sub-type of POI, or a type of restaurant POI, associated with the POI 108) may be provided. In other embodiments, additional, different, or fewer types and/or sub-types may be used, and/or the types and/or sub-types may be arranged or defined differently.

Alternatively or additionally, the advertising content 240 may be provided based on a pre-determined or defined spatial area. The advertising content 240 associated with a geographic location within the pre-determined spatial area or generally associated with that pre-determined spatial area may be provided. The pre-determined spatial area corresponds to or is associated with the geographic location or position of the client device 154 (determined, for example, using the positioning system of the client device 154) and/or the geographic location or position of one or more perceived inaccuracies in the map report. The pre-determined or defined spatial area may be of any size and/or shape. For example, the pre-defined spatial area may be a circular region having a specified radius (e.g., 1 mile, 2 miles, etc.). As another example, the pre-defined spatial area may correspond to a sub-region in the geographic region 100, such as a neighborhood (e.g., Lakeview), a county (e.g., Cook County), etc., or the entire geographic region 100. The advertising content 240 associated with a geographic location

When, for example, the pre-determined spatial area is a circular region having a radius of 3 miles surrounding the geographic location of the client device 154, advertising content 240 associated with one or more locations within the 3-mile radius may be provided.

When, for example, the map report includes a perceived inaccuracy corresponding to a POI 108 and the pre-determined spatial area is a circular region having a radius of 1 mile surrounding the geographic location of the POI 108, the advertising content 240 associated with one or more locations within the 1 mile radius surrounding the geographic location of the POI 108 may be provided.

Alternatively or additionally, the advertising content 240 may be provided based on user specific data from one or more previous map reports stored in the end user database 208 and/or conditions and/or guidelines associated with the content 240. For example, when a condition associated with advertising content 240 indicates that the associated advertising content 240 should only be delivered on certain days, that advertising content 240 may only be provided so long as that condition are satisfied.

In other embodiments, the provision of the advertising content 240 to the client device 154 may be based on other information, factors, or parameters. For example, advertising content 240 may be provided based on the compensation that the system operator 166 will receive for providing that advertising content 240 to the client device 154.

The advertising content 240 may be provided to the client device 154 upon (e.g., immediately following) or in response to receiving the map report, at a later time (e.g., the next time the client application 320 is executing on the client device 154), or in response to a request for advertising content from the client application 320. The advertising application 272 is configured to provide advertising content 240 from the advertising database 204 to the client device 154 via the network 170. Alternatively or in addition thereto, the advertising application 272 may provide advertising content 240 from the advertising database 204 to the client device 154 via one or more proxy servers. In embodiments in which the advertising database 204 is separate (e.g., remote) from the server 216, the advertising application 272 may request advertising content 240 from the advertising database 204 and provide that content 240 to the client device 154, or may request that the advertising content 240 be sent from the advertising database 204 to the client device 154.

The advertising content 240 is configured to be provided (e.g., output, displayed) in or as part of the client application 320. For example, the advertising content 240 may be displayed in the client application 320 via the display 320 of the client device 154. The advertising content 240 may be provided with or without digital content. For example, the advertising content 240 may be configured to be displayed in the client application 320 in combination with digital content. Depending on the format of the advertising content, the advertising content 240 may be configured to be displayed to the end user 158 as a webpage, a screenshot, an ad banner or window, scrolling text, an information page, other image, or video, may be configured to be output to the end user 158 as text, audio, or video, in some other way, or combinations thereof. In other embodiments, the advertising content 240 may also or alternatively be provided in other applications executing on the client device 154.

Advertising content may be provided to the client device 154 any number of different times (e.g., based on a plurality of map reports) and/or may be provided to a plurality of client devices 154.

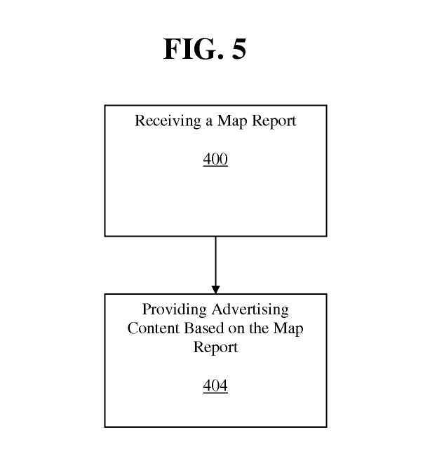

FIG. 5 shows a flow chart depicting a method or operation for providing advertising content based on a map report. The method or operation may be implemented using the system 150 described above. In other embodiments, a different system may be used. The method is implemented in the order shown, but may be implemented in or according to any number of different orders. Additional, different, or fewer acts may be provided. For example, any number of map reports may be received from a client device, in which case advertising content may be provided based on (e.g., in response to) one or more of these map reports. As another example, one or more map reports may be received from each of a plurality of client devices, and advertising content to each client device may be provided based on the respective map reports.

A map report may be received from a client device (e.g., the client device 154) (act 400). The map report is indicative of a perceived inaccuracy in geographic data stored in a geographic database (e.g., the geographic database 200). The perceived inaccuracy may include existing geographic data to be deleted or removed, erroneous geographic data, missing or omitted geographic data, or combinations thereof. The perceived inaccuracy may be identified using or via the client device, such as using an input device, a display, a positioning system, a camera, other component, or combinations thereof, of the client device. The map report may be generated by the client device. In one embodiment, the map report is generated in or by a client application (e.g., the client application 320) executing on the client device).

Advertising content (e.g., the advertising content 240) may be provided to the client device based on the map report (act 404). The advertising content may be provided to the client device based on a type of the map report and/or the perceived inaccuracy. The advertising content may, for example, be provided to the client device, based on a type or first hierarchical category of the perceived inaccuracy (e.g., a restaurant POI, a hotel POI, a highway road segment, etc.) or a sub-type or second hierarchical category (lower than the first hierarchical category) of the perceived inaccuracy (e.g., a steak restaurant POI, a luxury hotel POI, etc.)

In some embodiments, the method or operation may further include extracting information from the map report. The advertising content may, in turn, be provided based on the extracted information. The extracting may include extracting activities, interests, behaviors, preferences, a location, or combinations thereof, of an end user (e.g., the end user 158) associated with the client device. The extracting may, additionally or alternatively, include extracting a type of the map report and/or information about the perceived inaccuracy, such as, for example, a type of the perceived inaccuracy and/or a sub-type of the perceived inaccuracy.

As noted above, the geographic system 162, or individual components thereof, may be implemented as computer program logic or computer readable program code stored in the memory and/or storage of a computer, such as the computer 500. FIG. 6 illustrates an embodiment of the computer system 500. The computer system 500 can include a set of instructions that can be executed to cause the computer system 500 to perform any one or more of the methods or computer based functions disclosed herein. The computer system 500 may operate as a standalone device or may be connected, e.g., using a network, to other computer systems or peripheral devices. Any of the components discussed above may be a computer system 500 or a component in the computer system 500.

In a networked deployment, the computer system 500 may operate in the capacity of a server or as a client user computer in a client-server user network environment, or as a peer computer system in a peer-to-peer (or distributed) network environment. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine In a particular embodiment, the computer system 500 can be implemented using electronic devices that provide voice, video or data communication. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 6, the computer system 500 may include a processor 502, e.g., a central processing unit (CPU), a graphics processing unit (GPU), or both. The processor 502 may be a component in a variety of systems. For example, the processor 502 may be part of a standard personal computer or a workstation. The processor 502 may be one or more general processors, digital signal processors, application specific integrated circuits, field programmable gate arrays, servers, networks, digital circuits, analog circuits, combinations thereof, or other now known or later developed devices for analyzing and processing data. The processor 502 may implement a software program, such as code generated manually (i.e., programmed).

The computer system 500 may include a memory 504 that can communicate via a bus 508. The memory 504 may be a main memory, a static memory, or a dynamic memory. The memory 504 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 504 includes a cache or random access memory for the processor 502. In alternative embodiments, the memory 504 is separate from the processor 502, such as a cache memory of a processor, the system memory, or other memory. The memory 504 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 504 is operable to store instructions executable by the processor 502. The functions, acts or tasks illustrated in the figures or described herein may be performed by the programmed processor 502 executing the instructions stored in the memory 504. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 500 may further include a display unit 514, such as a liquid crystal display (LCD), an organic light emitting diode (OLED), a flat panel display, a solid state display, a cathode ray tube (CRT), a projector, a printer or other now known or later developed display device for outputting determined information. The display 514 may act as an interface for the user to see the functioning of the processor 502, or specifically as an interface with the software stored in the memory 504 or in the drive unit 506.

Additionally, the computer system 500 may include an input device 516 configured to allow a user to interact with any of the components of system 500. The input device 516 may be a number pad, a keyboard, or a cursor control device, such as a mouse, or a joystick, touch screen display, remote control or any other device operative to interact with the system 500.

In a particular embodiment, as depicted in FIG. 5, the computer system 500 may also include a disk or optical drive unit 506. The disk drive unit 506 may include a computer-readable medium 510 in which one or more sets of instructions 512, e.g. software, can be embedded. Further, the instructions 512 may embody one or more of the methods or logic as described herein. In a particular embodiment, the instructions 512 may reside completely, or at least partially, within the memory 504 and/or within the processor 502 during execution by the computer system 500. The memory 504 and the processor 502 also may include computer-readable media as discussed above.

The present disclosure contemplates a computer-readable medium that includes instructions 512 or receives and executes instructions 512 responsive to a propagated signal, so that a device connected to a network 520 can communicate voice, video, audio, images or any other data over the network 520. Further, the instructions 512 may be transmitted or received over the network 520 via a communication port 918. The communication port 518 may be a part of the processor 502 or may be a separate component. The communication port 518 may be created in software or may be a physical connection in hardware. The communication port 518 is configured to connect with a network 520, external media, the display 514, or any other components in system 500, or combinations thereof. The connection with the network 520 may be a physical connection, such as a wired Ethernet connection or may be established wirelessly as discussed below. Likewise, the additional connections with other components of the system 500 may be physical connections or may be established wirelessly.

The network 520 may include wired networks, wireless networks, or combinations thereof, and may be representative of the network 170. The wireless network may be a cellular telephone network, an 802.11, 802.16, 802.20, or WiMax network. Further, the network 520 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a)hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network.

The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

I claim:

1. An apparatus comprising:
at least one processor; and
at least one memory including computer program code for one or more programs, the at least one memory and the computer program code configured to, with the at least one processor, cause the apparatus to perform at least the following:
transmit, to a server, a change relating to geographic data stored in a geographic database, the change indicative of a perceived inaccuracy in the geographic data;
receive advertising content from the server, the advertising content selected based on the change; and
provide the advertising content to an end user associated with the apparatus.

2. The apparatus of claim 1, wherein the change is indicative of geographic data omitted from the geographic database, geographic data to be removed from the geographic database, or erroneous geographic data to be corrected in the geographic database.

3. The apparatus of claim 1, wherein the at least one memory and the computer program code are configured to, with the at least one processor, cause the apparatus to:
form a map report including the change, the map report indicative of the perceived inaccuracy in the geographic data;
transmit the map report to the server; and
receive the advertising content from the server, the advertising content selected based on the map report.

4. A method comprising:
receiving, from a client device, a map report indicative of a perceived inaccuracy in geographic data stored in a geographic database; and
providing, via a processor, advertising content to the client device based on the map report.

5. The method of claim 4, wherein receiving the map report comprises receiving a map report generated in a client application executing on the client device, and wherein the advertising content is to be provided in the client application executing on the client device.

6. The method of claim 4, further comprising extracting information from the map report, and wherein providing advertising content comprises providing advertising content based on the information extracted from the map report.

7. The method of claim 6, wherein extracting information comprises extracting activities, interests, or preferences of an end user associated with the client device from the map report, and wherein providing advertising content comprises providing the advertising content based on the activities, interests, or preferences extracted from the map report.

8. The method of claim 6, wherein extracting information comprises extracting a type of the map report, and wherein providing advertising content comprises providing advertising content based on the type of the map report.

9. The method of claim 4, wherein providing advertising content comprises providing advertising content in response to the receiving.

10. The method of claim 4, wherein providing advertising content comprises providing advertising content to the client device based on the perceived inaccuracy.

11. The method of claim 4, further comprising generating the advertising content based on the map report.

12. The method of claim 4, further comprising determining, from the map report, a geographic location of the client device, wherein providing advertising content comprises providing advertising content to the client device based on the perceived inaccuracy and a pre-determined spatial area associated with the geographic location of the client device.

13. The method of claim 4, further comprising extracting information from the map report, the information including a first hierarchical map category associated with the perceived inaccuracy, wherein providing advertising content comprises providing advertising content to the client device based on the first hierarchical map category.

14. The method of claim 4, further comprising extracting information from the map report, the information including a second hierarchical map category associated with the perceived inaccuracy, wherein providing advertising content comprises providing advertising content to the client device based on the second hierarchical map category.

15. A system comprising:
a geographic database configured to store geographic data for a geographic region; and
a server configured to receive, from a client device, a change indicative of a perceived inaccuracy in the geographic data,
wherein the server is configured to provide, as a function of the change, advertising content to the client device.

16. The system of claim 15, wherein the change is indicative of geographic data omitted from the geographic database, geographic data to be removed from the geographic database, or erroneous geographic data to be corrected in the geographic database.

17. The system of claim 15, wherein the server is configured to receive, from the client device, a map report including the change, and wherein the server is configured to provide, as a function of the map report, the advertising content to the client device.

18. The system of claim 17, wherein the server is configured to extract information from the map report, and wherein the advertising content is provided as a function of the extracted information.

19. The system of claim 18, wherein the information comprises a type of the map report, a type of the perceived inaccuracy, a sub-type of the perceived inaccuracy, activities, interests, or a location of an end user associated with the client device, or combinations thereof.

20. The system of claim 19, wherein the server is configured to provide, as a function of the information extracted from the change and a pre-defined spatial area, the advertising content to the client device.
